(19) United States
(12) Patent Application Publication
(10) Pub. No.: US 2009/0315913 A1
(43) Pub. Date: Dec. 24, 2009

(54) MAP DISPLAY SYSTEM

(75) Inventors: Kazumasa Nagashima, Kanagawa (JP); Eriko Ohdachi, Kanagawa (JP); Noboru Katta, Kanagawa (JP)

Correspondence Address: RATNERPRESTIA, P.O. BOX 980, VALLEY FORGE, PA, 19482, US

(73) Assignee: Panasonic Corporation, Osaka (JP)

(21) Appl. No.: 12/374,547

(22) PCT Filed: Jun. 14, 2007
(86) PCT No.: PCT/JP2007/061971

§ 371 Date: Jan. 21, 2009

(30) Foreign Application Priority Data
Jul. 21, 2006 (JP) 2006-199195

(51) Int. Cl. G09G 5/00; G08G 1/123

(52) U.S. Cl. 345/629; 345/660; 340/995.17

(57) ABSTRACT

A map display system includes a first map image generating section configured to generate a first map image, a second map image generating section configured to generate a second map image larger in scale than the first map image at intervals lower than intervals which the first map image is generated at, a first display device configured to display a first composite map image generated by overlaying, on the first map image generated by the first map image generating section, a first mark image indicating a current position and a traveling direction of a moving object, a second display device configured to display a second composite map image generated by overlaying, on the second map image generated by the second map image generating section, a second mark image indicating the current position and the traveling direction of the moving object.

### FIELD OF THE INVENTION

The present invention relates to a map display system for displaying two or more map images different in scale from each other.

### BACKGROUND OF THE INVENTION

In the above-mentioned conventional map display system, two map data different in scale from each other are firstly read from map data stored in CD-ROM. Two image data are then generated from the map data, and respectively stored in first and second video random access memory (VRAM) by a processor. The image data stored in the first and second VRAM are respectively converted by the first and second video controllers to video signals to be respectively outputted to first and second display devices so that the above-mentioned map display system can display two road maps different in scale from each other on the first and second display devices. It is easy for a driver to check a travelling route or the like. Here, scales of two road maps to be displayed on the first and second display devices are determined by a user through a setting menu (see for example Patent document 1).

Patent document 1: Japanese Patent Laying-Open Publication No. H09-257497

### DISCLOSURE OF THE INVENTION

### Problems to be solved by the Invention

The above-mentioned conventional map display system however encounters such a problem that a heavy workload, resulting from the fact that two different image data generated with the same frequency, is imposed on a processor.

It is therefore an object of the present invention to provide a map display system which can reduce a processing workload on a processor.

### Means for solving the Problems

In order to attain the above-mentioned object, a map display system according to the present invention comprises: a first map image generating section configured to generate a first map image; a second map image generating section configured to generate a second map image larger in scale than the first map image at intervals lower than intervals at which the first map image is generated; and a display section configured to display the first map image generated by the first map image generating section and the second map image generated by the first map image generating section.

The map display system according to the present invention may be realized by an integrated circuit as another aspect.

### Advantageous Effect of the Invention

In the map display system according to the present invention, the second map data larger in scale than the first map data is generated at intervals lower than intervals at which the first map image is generated. Therefore, the map display system according to the present invention can reduce a processing workload on a processor.

### BRIEF DESCRIPTION OF THE DRAWINGS

FIG. 1 is a block diagram illustrating a configuration of a map display system according to one embodiment of the present invention.

FIG. 2 is a schematic view illustrating a display section installed in a vehicle as part of the map display system according to one embodiment of the present invention.

FIG. 3 is a schematic diagram illustrating data flow to be controlled by a control section forming part of the map display system according to one embodiment of the present invention.

FIG. 4 is a schematic view illustrating a map image, a mark image, and a composite map image generated by the map display system according to one embodiment of the present invention.

FIG. 5 is a flow chart explaining an operation of the map display system according to one embodiment of the present invention.

FIG. 6 is a flow chart explaining in detail part of the flow chart of FIG. 5.

FIG. 7 is a flow chart explaining in detail part of the flow chart of FIG. 6.

FIG. 8 is a first example of images displayed by the display section forming part of the map display system according to one embodiment of the present invention.

FIG. 9 is a second example of images displayed by the display section forming part of the map display system according to one embodiment of the present invention.

FIG. 10 is a third example of images displayed by the display section forming part of the map display system according to one embodiment of the present invention.

FIG. 11 is fourth example of images displayed by the display section forming part of the map display system according to one embodiment of the present invention.

FIG. 12 is a fifth example of images displayed by the display section forming part of the map display system according to one embodiment of the present invention.

FIG. 13 is a sixth example of images displayed by the display section forming part of the map display system according to one embodiment of the present invention.

### EXPLANATION OF THE REFERENCE NUMERALS

1: map display system

2: control section (integrated circuit)

10: CPU

11: RAM

12: ROM

13: storage device

3: display section

30: first display device

31: second display device

4: input section

40: first input device

41: second input device

### PREFERRED EMBODIMENT OF THE INVENTION

One preferred embodiment of the map display system according to the present invention will hereinafter be described with reference to accompanying drawings.

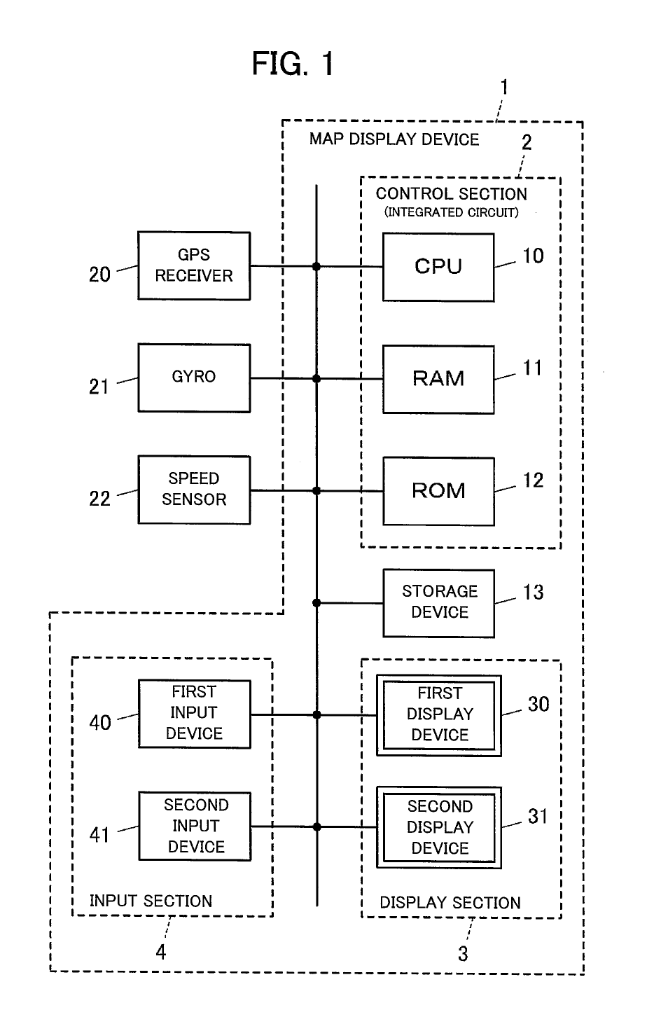

FIG. 1 is a block diagram illustrating a configuration of the map display system 1 according to the preferred embodiment of the present invention. As shown in FIG. 1, the map display system 1 is installed in a vehicle exemplified as a typical example of a moving object, and comprises at least an input section 4, a storage device 13, a control section 2, and a display section 3.

The storage device 13 includes a memory medium such as magnetic disc (e.g., hard disc), optical disc (e.g., DVD (digital versatile disc)), or semiconductor memory. The memory medium includes, as well as a program to be executed by a CPU (central processing section) 10 which will hereinafter be described, a map database required to generate a map image, to search an optimum route, or to perform another navigation functions. The map database includes geographic information previously prepared in every scale, and required to display the map image. The geographic information includes information on geographies such as for example roads, intersections, buildings and rivers, and information on explanations and/or advertisements about each geography. The geographic information further includes information about connection between two or more roads, the number of lanes of each road, and/or traffic regulation such as one-way road and the like.

The control section 2 includes, in addition to the CPU 10, a RAM (random access memory) 11 and a ROM (read only memory) 12. The CPU 10 loads the program from the ROM 12 and the storage device 13 into the RAM 11, and executes the program loaded into the RAM 11 to control each part of the map display system 1. For example, the CPU 10 determines a current position of the vehicle and a direction in which the vehicle is traveling on a map by using an output from a GPS receiver 20, an output from a gyro 21, an output from a speed sensor 22, and map data loaded from the storage device 13. Further, the CPU 10 generates, in the RAM 11, a map image (hereinafter referred to as “first map image”) indicative of an area surrounding the vehicle, the first map image being displayed by a first display device 30 which will hereinafter be described. The CPU 10 generates, in the RAM 11, a map image (hereinafter referred to as “second map image”) indicative of an area surrounding the vehicle, and different in scale from the first map image.

In the following description, scales of maps are respectively represented by scales. The CPU 10 adds two scales (hereinafter referred to as “scale image”) to the first and second map images. Each of the scales has a linear object predetermined in length, and a numeric value defined as an actual distance. If, for example, the numeric value of the scale added to the map is reduced, the scale of the map is increased. As a result, the map is zoomed in, and displayed in detail as a narrow-area map. If, on the other hand, the numeric value of the scale added to the map is increased, the scale of the map is reduced. As a result, the map is zoomed out, and displayed as a wide-area map. For example, the map displayed by the second display device 31 with a scale indicating a distance of 400 meters indicates a wide area in comparison with the map displayed by the first display device 30 with a scale indicating a distance of 50 meters.

In this embodiment, the input section 4 includes a first input device 40, and a second input device 41. Each of the first and second input devices 40 and 41 is constituted by a remote controller or a touch panel. The first input device 40 has a button switch operable to change the scale (hereinafter referred to as “scale A”) of the map to be displayed by the first display device 30, while the second input device 41 has a button switch operable to change the scale (hereinafter referred to as “scale B”) of the map to be displayed by the second display device 31. Therefore, it is possible for a user to designate each scale of the maps to be displayed by the first and second display devices 30 and 31.

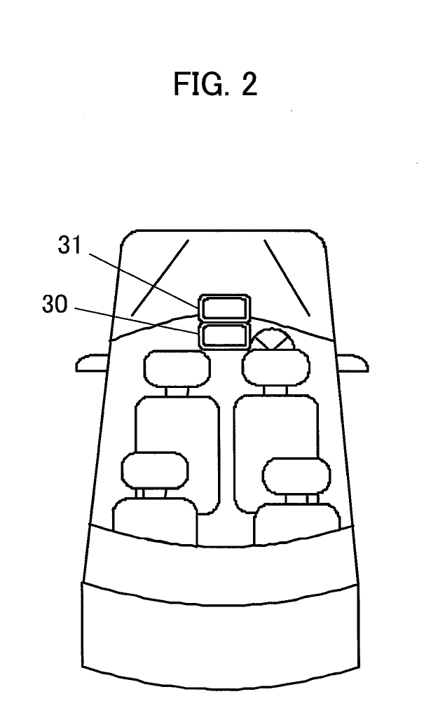

The display section 3 includes a first display device 30 and a second display device 31. Each of the first and second display devices 30 and 31 is constituted by for example a liquid crystal display device, or an organic electro-luminescence display device. As shown in FIG. 2, the first and second display devices 30 and 31 are arranged in a place that a vehicle occupant (e.g., driver) can visually recognize the displayed information.

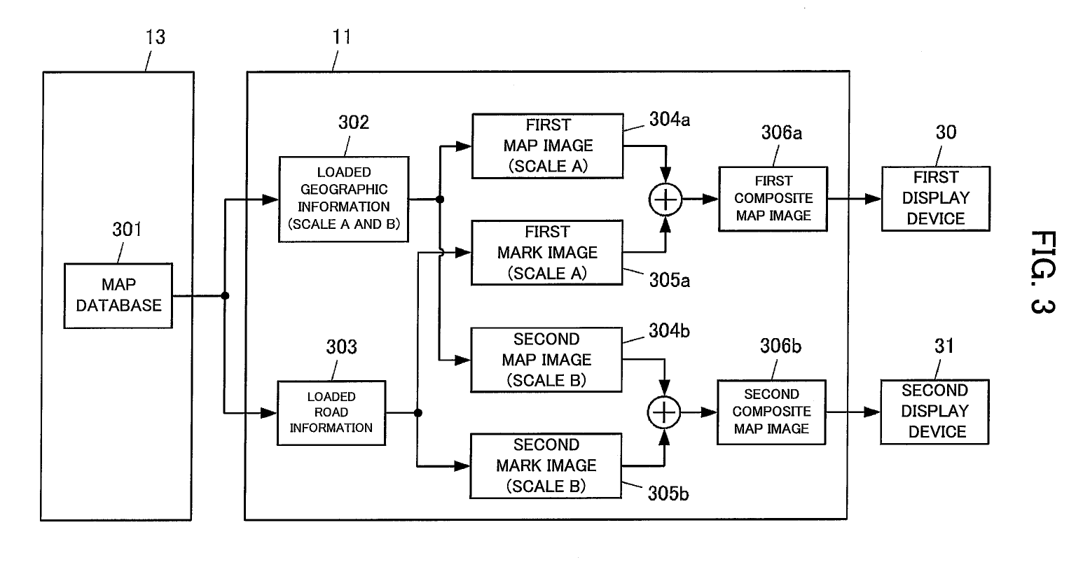

FIG. 3 is a schematic diagram illustrating the flow of data processing in the control section 2 shown in FIG. 1. Only the storage device 13, the RAM 11, and the first and second display devices 30 and 31 are illustrated in FIG. 3, but this is just for the sake of simplicity.

The storage device 13, as shown in FIG. 3, stores a map database 301 including road information and geographic information previously prepared in every scale.

The geographic information corresponding to the scales A and B are read by the CPU 10 from the map database 301, and then expanded in the RAM 11 of the control section 2 as loaded geographic information 302 corresponding to the scales A and B. The loaded geographic information 302 is used as a basis for the first and second map images. Further, the loaded geographic information 302 to be required to generate at least one frame of the first and second map images is expanded in the RAM 11.

The road information is read by the CPU 10 from the map database 301 at periodic intervals, expanded as loaded road information 303 in the RAM 11 of the control section 2, and used to identify a current position and a current traveling direction of the vehicle on each map. The loaded road information 303 is also used with calculation of coordinates and direction of the mark image (hereinafter referred to as “first mark image”) to be overlaid on the first map image, and calculation of coordinates and direction of the mark image (hereinafter referred to as “second mark image”) to be overlaid on the second map image.

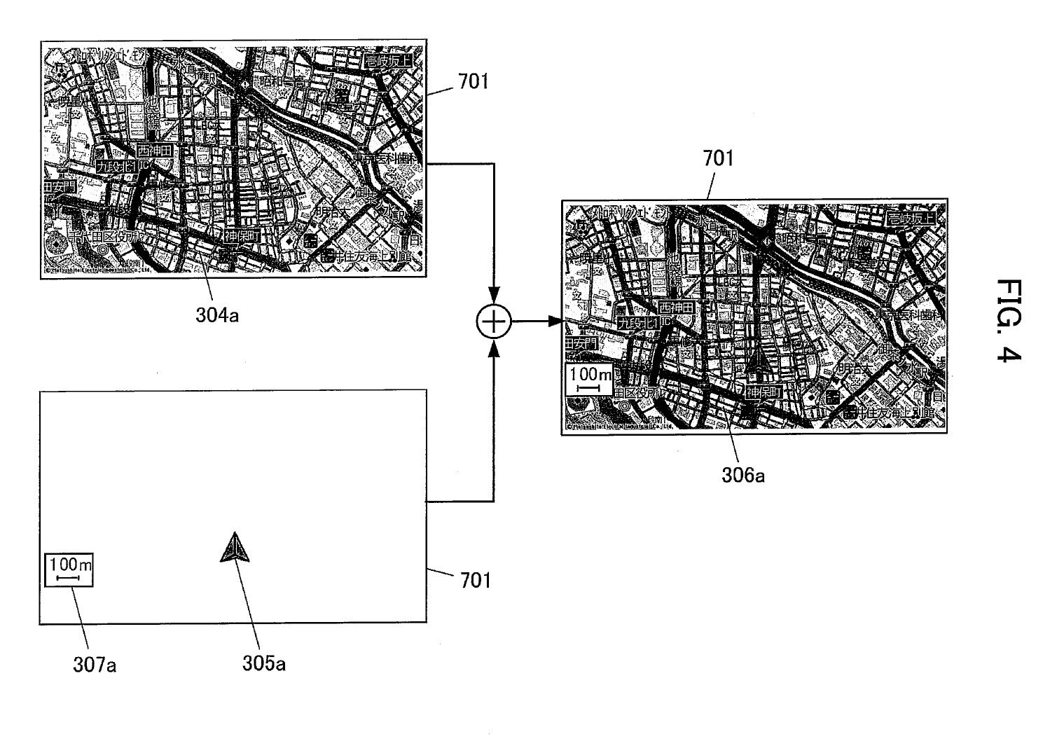

The first map image 304a is generated by the CPU 10 on the basis of the loaded geographic information 302, and represents one frame of a map (with the scale A) to be displayed by the first display device 30 as shown in FIG. 4. If changing from a current display mode to another display mode such as heading up and three dimensional modes, the CPU 10 processes the first map image 304a to rotate or change the direction of the first map image 304a, or if the scale of the first map image 304a is specifically designated by the first input device 40, the CPU 10 scales up or down the first map image 304a on the basis of a scale designated specifically by the first input device 40, and extends the first map image 304a in the RAM 11.

As will be seen from FIG. 3, there is no difference between the first map image 304a and the second map image 304b, except that the second map image 304b is generated from the loaded geographic information 302 corresponding to the scale B different from the scale A. Therefore, the second map image 304b will not described hereinafter.

The first mark image 305a stored in for example the storage device 13 is overlaid on the first map image 304a corresponding to the scale A, and indicates a current position and a travelling direction of the vehicle on the map with the scale A. More specifically, the first composite map image 306a is generated on the RAM 11 through step of overlaying the first mark image 305a on the first map image 304a under the condition that coordinates and a direction of the first mark image 305a on the map with the scale A correspond to the current position and the traveling direction of the vehicle.

In the same manner, the second mark image 305b stored in for example the storage device 13 is overlaid on the second map image 304b corresponding to the scale B, and indicates a current position and a travelling direction of the vehicle on the map with the scale B. More specifically, the second composite map image 306b is generated on the RAM 11 through step of overlaying the second mark image 305b on the second map image 304b under the condition that coordinates and a direction of the second mark image 305b on the map with the scale B correspond to the current position and the traveling direction of the vehicle.

The operation of overlaying the first mark image 305a on the first map image 304a will be specifically described hereinafter with reference to FIG. 4, which is a schematic view of a region 701 to be displayed on a screen of the first display device 30.

The CPU 10 generates the first map image 304a by performing various processing such as rotation and scaling of the loaded geographic information 302 in the RAM 11.

Further, the first mark image 305a is generated by the CPU 10 in the RAM 11. The first mark image 305a is used for displaying the coordinates position at which the vehicle currently is present in the region 701 and a direction to which the vehicle currently travels as shown in FIG. 4. In this embodiment, the first scale image 307a for indicating the scale of the first map image 304a is also generated by the CPU 10.

As shown in FIG. 4, the CPU 10 generates the first composite map image 306a by overlaying the first mark image 305a on the first map image 304a in the RAM 11.

Further, the CPU 10 generates the second composite map image 306b in the same manner as the first composite map image 306a.

The first and second composite map images 306a and 306b are respectively inputted into the first and second display devices 30 and 31, while the CPU 10 controls the first and second display devices 30 and 31 to have the first display device 30 display the first composite map image 306a (scale A), and to have the second display device 31 display the second composite map image 306b (scale B).

As will be seen from FIG. 4, the first map image 304a is, in general, incomparably larger than the first mark image 305a in amount of information. Therefore, a processing workload is imposed on the CPU 10 while the first map image 304a is generated by the CPU 10, and is much larger than a processing workload to be imposed on the CPU 10 while the first mark image 305a is generated by the CPU 10. Similarly, a processing workload is imposed on the CPU 10 while the second map image 304b is generated by the CPU 10, and is much larger than a processing workload to be imposed on the CPU 10 while the first mark image 305b is generated by the CPU 10.

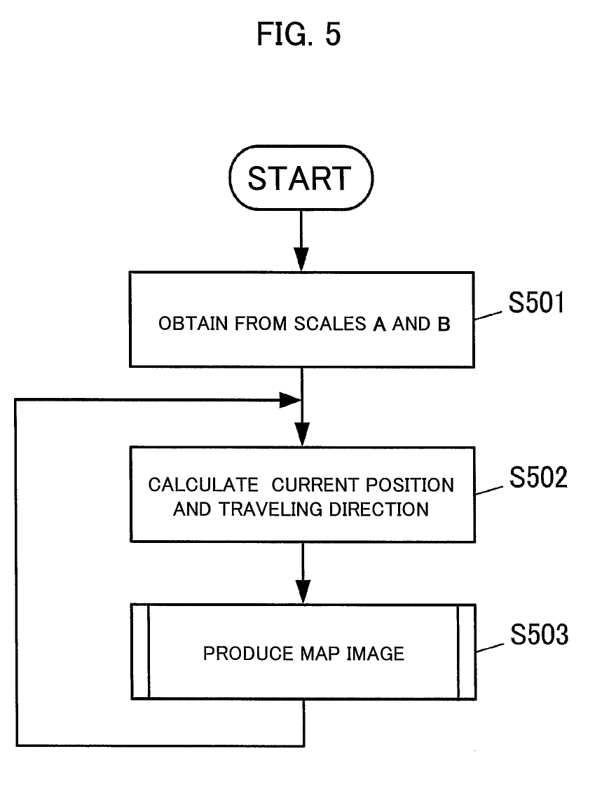

The operation of the map display system 1 shown in FIG. 1 will be then described hereinafter with reference to flow charts of FIGS. 5 to 7.

FIG. 5 is a main flow chart illustrating a general operation to be performed in the map display system 1 shown in FIG. 1. The general operation of the map display system 1 will be explained hereinafter with reference to FIG. 5.

In the map display system 1, a user can designate the scale A of the map to be displayed by the first display device 30 by operating the first input device 40, and designate the scale B of the map to be displayed by the second display device 31 by operating the second input device 41. The scales A and B designated by the user are received by the CPU 10 from the first and second input devices 40 and 41 (in step S501).

While the vehicle is traveling, the current position of the vehicle is changing with time. Therefore, the current position and the current traveling direction of the vehicle are calculated at periodic intervals by the CPU 10 (in step S502). In this step, the CPU 10 calculates the current position and the current traveling direction of the vehicle on the basis of outputs from the GPS receiver 20, the gyro 21, and the speed sensor 22, and adjusts the current position and the current traveling direction of the vehicle to the coordinates and a direction of a road on the map. Then, the CPU 10 generates a map image surrounding the current position of the vehicle (in step S503), and performs the above operations in steps S502 and S503 at periodic intervals.

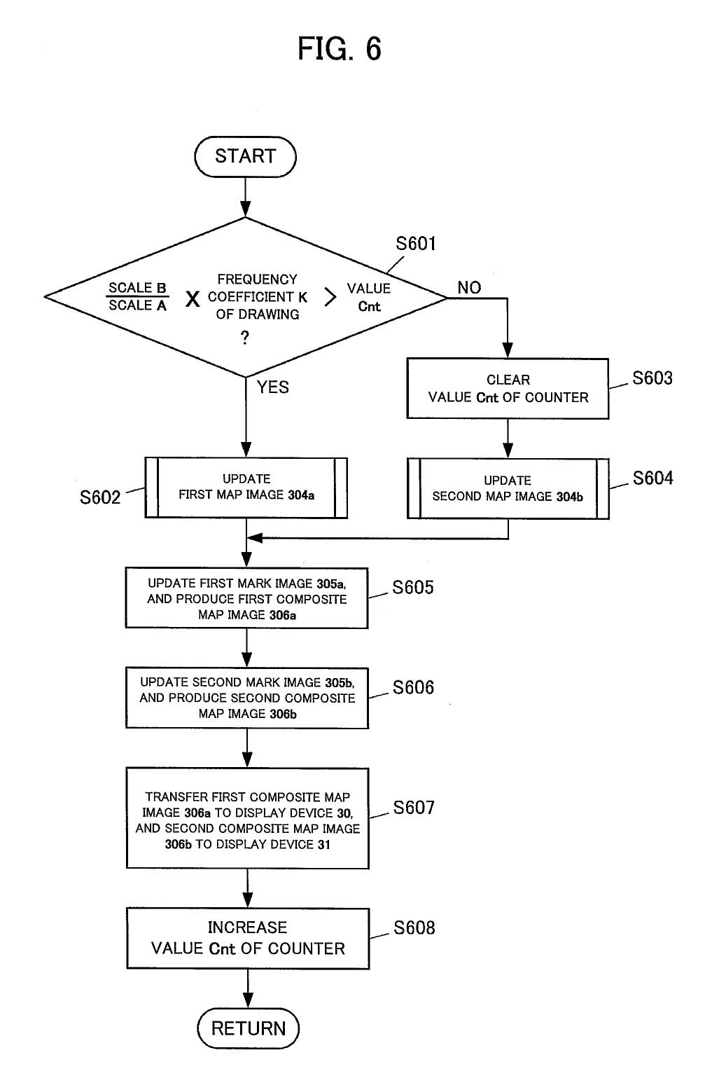

FIG. 6 is a flow chart explaining in detail the data processing to be performed in step S503. The focus of the routine based on the flow chart of FIG. 6 is to reduce a processing workload by decreasing an update rate of a large-scaled map. Therefore, the update rate of each map is controlled on the basis of a ratio of the scale of the map displayed by the first display device 30 and the scale of the map displayed by the second display device 31.

The following simplified explanation is based on assumption that the scale A of the map displayed by the first display device 30 is smaller than the scale B of the map displayed by the second display device 31, and more specifically the first display device 30 zooms in and displays an area smaller than the map displayed by the second display device 31.

The CPU 10 makes a determination on whether or not a value obtained by dividing the scale B received in step S501 by the scale A and multiplied by a predetermined coefficient “K” is larger than a value Cnt of a counter (in step S601). Here, the coefficient “K” is defined on the basis of each system, and equal to or smaller than numeral “1”. The value Cnt of the counter is initialized if the system is started or rebooted.

If the answer in step S601 is “Yes”, the CPU 10 generates and updates, in the manner previously explained with reference to FIGS. 3 and 4, the first map image 304a indicating a map with a scale A (in step S602).

If, on the other hand, the answer in step S601 is “No”, the CPU 10 resets the value Cnt of the counter (in step S603), and then the CPU 10 generates and updates, in the manner previously explained, the second map image 304b indicating a map with a scale B (in step S604).

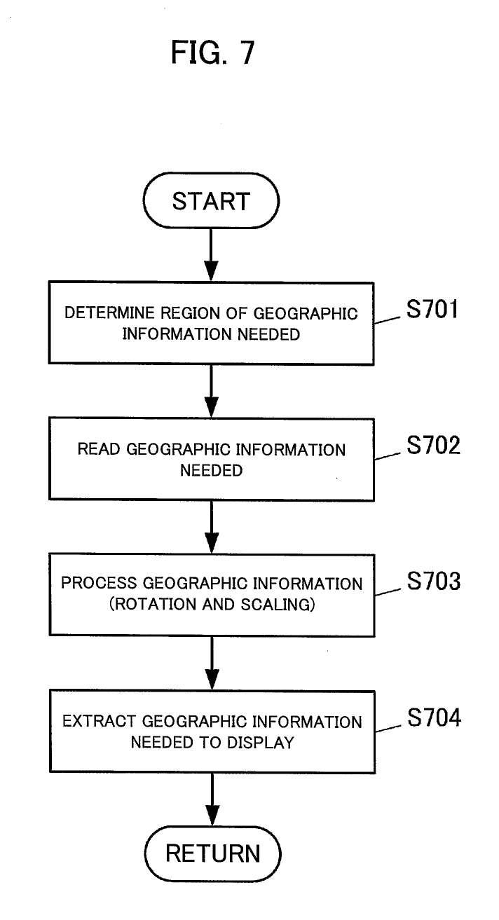

The data processing to be performed in steps S602 and S604 is then described in detail with reference to FIG. 7.

As shown in FIG. 7, the CPU 10 specifies an area forming part of the map under the condition that the current position of the vehicle corresponds to points fixed on the first and second display devices 30 and 31 (for example, the center of each screen) in step S701, and then loads geographic information corresponding to the specified area from the memory device 13 into the RAM 11 (in step S702).

If necessary, the CPU 10 rotates and/or scales the loaded geographic information 302 (in step S703). Then, the CPU 10 generates the first and second map images 304a and 304b be respectively displayed by the first and second display devices 30 and 31 by extracting sections necessary to generate the first and second map images 304a and 304b from the loaded geographic information 302 (in step S704). The CPU 10 completes the data processing of steps S602 and S604 by completing the above-mentioned routines.

The CPU 10 performs the operation in step S605 after step S602 or step S604. In step S605, the CPU 10 identifies coordinates and a direction of the first mark image 305a on the first map image 304a. As a method of identifying the coordinates and the direction of the first mark image 305a on the first map image 304a, the CPU 10 converts the current position of the vehicle on the map into the current position of the vehicle on the first map image 304a (hereinafter referred to as “first current on-screen position”), and converts the current traveling direction of the vehicle on the map into the current traveling direction of the vehicle on the first map image 304a (hereinafter referred to as “first current on-screen direction”). The CPU 10 generates the first mark image 305a at the first current on-screen position, and directs the first mark image 305a in the first current on-screen direction. Additionally, the CPU 10 generates a first scale image 307a shown in FIG. 4.

Further, the CPU 10 generates the first composite map image 306a in step S605 by overlaying the first mark image 305a on the first map image 304a in the RAM 11.

The CPU 10 performs the operation in step S606 after step S605. In step S606, the CPU 10 identifies coordinates and a direction of the second mark image 305b on the second map image 304b. As a method of identifying the coordinates and the direction of the second mark image 305b on the second map image 304b, the CPU 10 converts the current position of the vehicle on the map into the current position of the vehicle on the second map image 304b (hereinafter referred to as “second current on-screen position”), and converts the current traveling direction of the vehicle on the map into the current traveling direction of the vehicle on the second map image 304b (hereinafter referred to as “second current on-screen direction”). The CPU 10 generates the second mark image 305b at the second current on-screen position, and directs the second mark image 305b in the second current on-screen direction. Additionally, the CPU 10 generates a scale image (not shown).

Further, the CPU 10 generates the second composite map image 306b in step S606 by overlaying the second mark image 305b on the second map image 304b in the RAM 11.

The method of identifying the coordinates and the direction of the first mark image 305a on the first map image 304a, and the coordinates and the direction of the second mark image 305b on the second map image 304b in steps S605 and S606 will be specifically described.

If the CPU 10 generates, from the loaded geographic information 302, the first and 5 second map images 304a and 304b corresponding to respective screens, the CPU 10 identifies latitudes and longitudes at four comers of each of the first and second map images 304a and 304b, and calculates the coordinates of the first mark image 305a on the first map image 304a, and the coordinates of the second mark image 305b on the second map image 304b by using the latitudes and longitudes, and the current position calculated in step S502.

If the CPU 10 generates, from the loaded geographic information 302, the first and second map images 304a and 304b corresponding to respective screens, the CPU 10 identifies the direction of the map represented by each map image by using latitudes and longitudes identified at two comers next to each other, and calculates the direction of each of the first and second mark images 305a and 305b by using the direction of each map, and current positions calculated in step S502.

The first and second composite map images 306a and 306b stored in the RAM 11 are respectively transmitted to the first and second display devices 30 and 31 by the CPU 10 (in step S607) after step S606. The first display device 30 displays the received first composite map image 306a (scale A) on its screen, while the second display device 31 displays the received second composite map image 306b (scale B) on its screen.

After step S607, the CPU 10 increases the value Cnt of the counter (in step S608) by a predetermined value (for example a numeral “1”). This is the end of step S503.

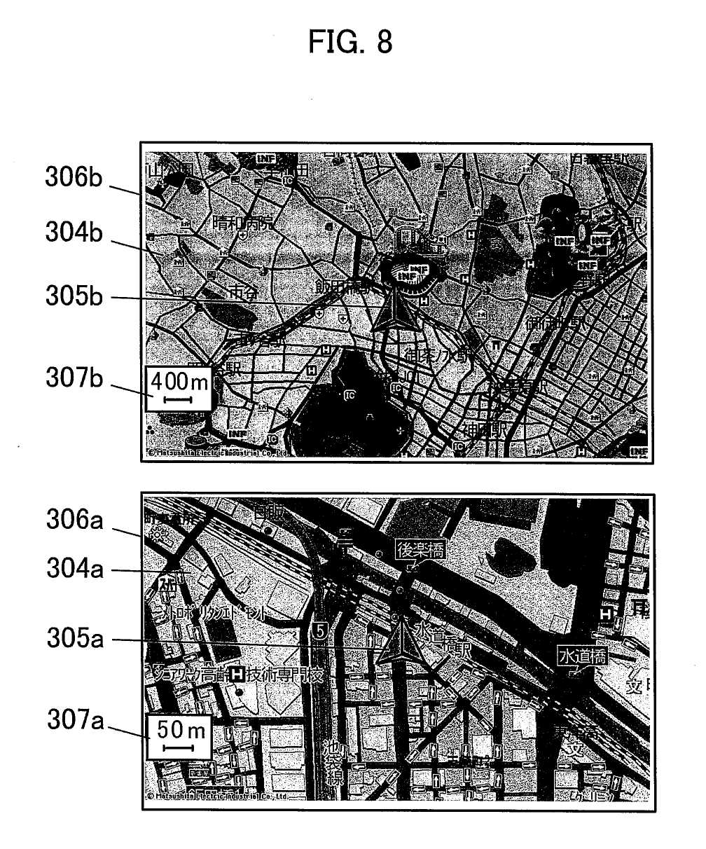

The following description has an assumption that a scale of 50 meters and a scale of 400 meters are respectively selected as scales of the maps to be displayed by the first and second display devices 30 and 31 as shown in FIG. 8. The changes of the first and second composite map images 306a and 306b to be displayed by the first and second display devices 30 and 31 will be explained hereinafter on the basis of the above-mentioned processing.

Here, the coefficient K is set to 0.5, and the value Cnt of the counter is set to an initial value “1”. The scale of the map displayed by the first display device 30 is 50 meters. Therefore, the scale A is 50 m. On the other hand, the scale of the map displayed by the second display device 31 is 400 meters. Therefore, the scale B is 400 m.

If scale B/scale A×coefficient K=400 m/50 m×0.5=4, and the value Cnt of the counter=1, the determination is made that the answer is “YES” in step S601 of the first round of the operation based on the flow chart of FIG. 6. Then, the CPU 10 proceeds to step S602, and updates the first map image 304a in step S602 on the basis of the current position and the current traveling direction of the vehicle in order to point the first mark image 305a in an upward direction at the center of the screen.

The CPU 10 points the first mark image 305a in an upward direction at the center of the first map image 304a updated in step S601 of the flow chart of FIG. 6, and generates the first composite map image 306a by overlaying the updated first mark image 305a and the first scale image 307a (see FIG. 4) on the first map image 304a.

The CPU 10 does not execute a routine corresponding to step S604 of this round, in other words, does not update the second map image 304b in step S604 of this round. Then, the CPU 10 updates the second mark image 305b, on the basis of the current position and the current traveling direction of the vehicle, on the second map image 304b held in the RAM 11 without being updated in step S604, and generates the second composite map image 306b by overlaying the updated second mark image 305b and the second scale image 307b on the second map image 304b.

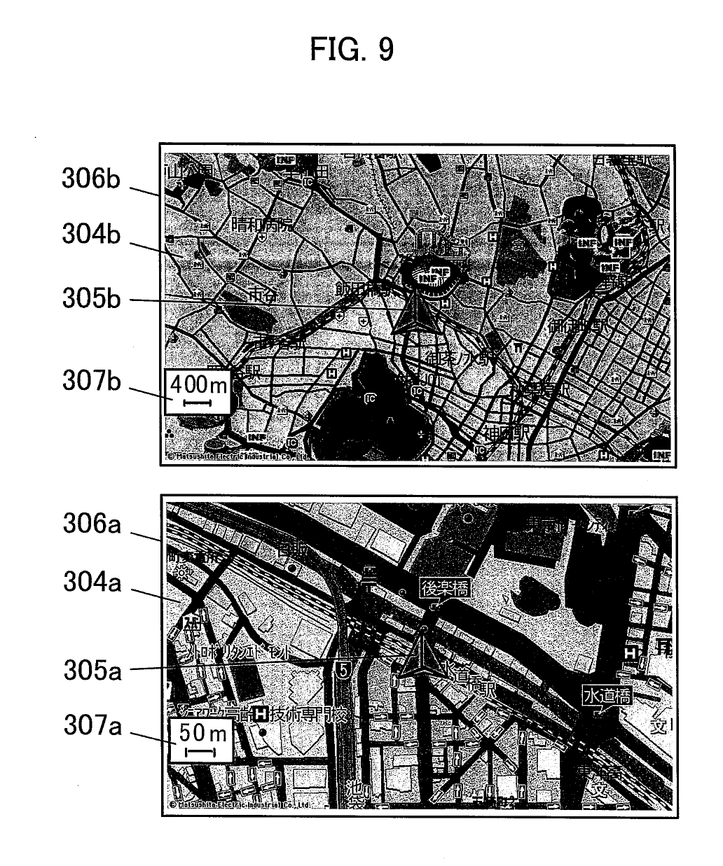

In step S607, the first and second composite map images 306a and 306b are respectively transferred to the first and second display devices 30 and 31 at the same time, and displayed as shown in FIG. 9.

In step S608, the CPU 10 increases the value Cnt of the counter to a numeral “2”, and completes the first round of operation based on the flow chart of FIG. 6.

The CPU 10 repeats the operation based on the flow chart of FIG. 5, calculates a current position of the vehicle and a direction in which the vehicle is traveling in step S502 of the second round, start to generate map images in step S503, and proceeds to step S601 of the second round of operation based on the flow chart of FIG. 6.

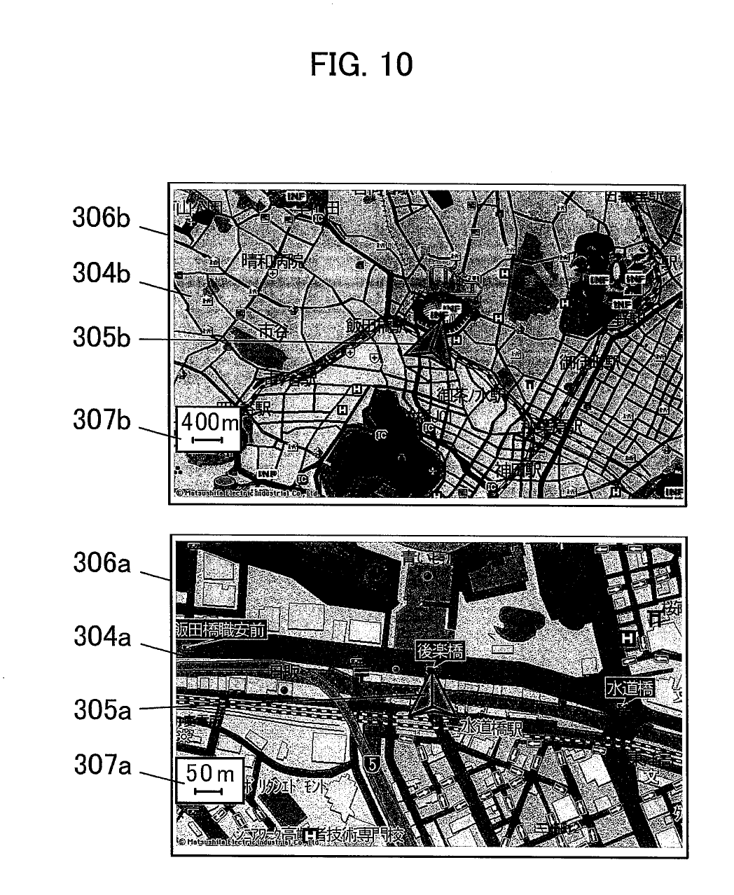

In step S601 of the second round, the value Cnt of the counter is “2”. Therefore, the relational expression results in 4>2. The determination is made that the answer is “YES”. The CPU 10 proceeds to step S602, and performs an operation the same as that of the first round. As a result, the first and second display sections 30 and 31 display the first and second composite map images 306a and 306b as shown in FIG. 10.

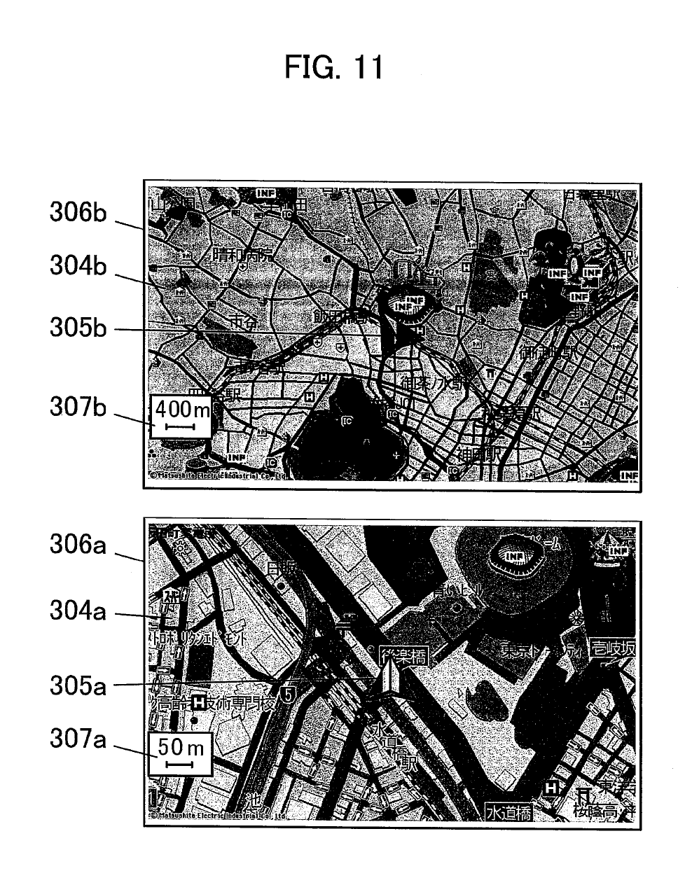

In step S601 of the third round, the value Cnt of the counter is “3”. Therefore, the relational expression results in 4>3. The determination is made that the answer is “YES”. The CPU 10 proceeds to step S602, and performs an operation the same as those of the first and second rounds. As a result, the first and second display sections 30 and 31 display the first and second composite map images 306a and 306b as shown in FIG. 11.

Therefore, the map display system can reduce a processing workload on a processor by reason that the second map image 304b is not updated in the first to third rounds of operations based on the flow chart of FIG. 5.

In step S601 of the fourth round, the value Cnt of the counter is “4”. Therefore, the relational expression results in 4>4. The determination is made that the answer is “NO”. The CPU 10 proceeds to step S603, resets the value Cnt of the counter to zero in step S603, and updates the second map image 304b in step S604 on the basis of the current position and the current traveling direction of the vehicle in order to point the second mark image 305b in an upward direction at the center of the screen.

In step S605, the CPU 10 points the first mark image 305a in an upward direction at the center of the first map image 304a held in the RAM 11 without being updated in step S602 of this round, and generates the first composite map image 306a by overlaying the updated first mark image 305a and the first scale image 307a on the first map image 304a.

The CPU 10 executes a routine corresponding to step S604 of this round, in other words, updates the second mark image 305b in step S604 of this round. Then, the CPU 10 updates the second mark image 305b, on the basis of the current position and the current traveling direction of the vehicle, on the updated second map image 304b, and generates the second composite map image 306b by overlaying the updated second mark image 305b and the second scale image 307b on the second map image 304b.

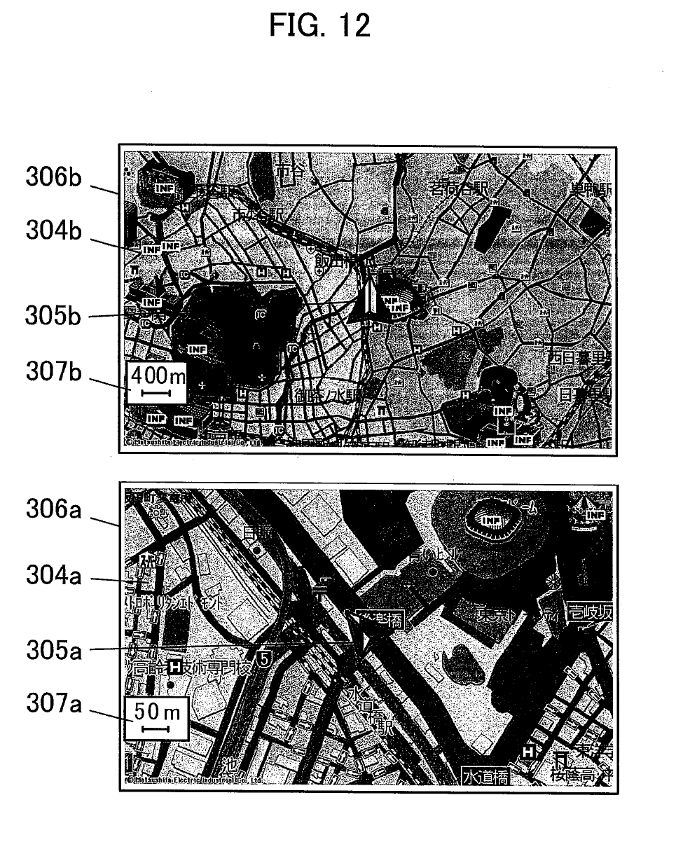

In step S607, the first and second composite map images 306a and 306b are respectively transmitted to the first and second display devices 30 and 31 at the same time, and displayed as shown in FIG. 12.

In step S608, the value Cnt of the counter is then increased to a numeral “1”.

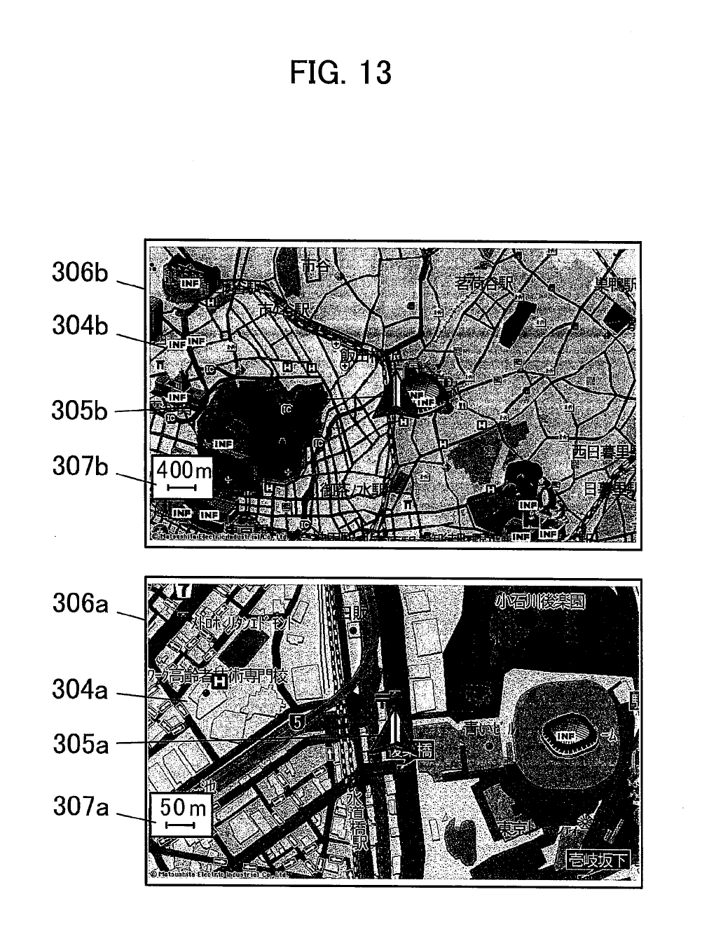

In the fifth round, the CPU 10 executes a routine the same as that of the first round. The determination is made that the answer is “YES” in step S601. The CPU 10 proceeds to step S603, and generates the first and second composite map images 306a and 306b as shown in FIG. 13.

From the foregoing description, it will be understood that the map display device according to the present invention can reduce a processing workload on the CPU 10 by reason that while the CPU 10 successively updates the first map image 304a indicative of a map with a small scale three times so that the first mark image 305a directs in an upward direction in the first map image 304a, the CPU 10 updates the direction and the position of the second mark image 305b without updating the second map image 304b indicative of a map with a large scale, if the CPU 10 updates the second map image 304b indicative of a map with a large scale so that the second mark image 305b directs in an upward direction in the next round, the CPU 10 updates the direction and the position of the first mark image 305a without updating the first map image 304a indicative of a map with a small scale, and the CPU 10 repeats the above-mentioned operation. Additionally, the displacement of the vehicle on the second map image 304b indicative of a map with a large scale is smaller than that of the vehicle on the first map image 304a indicative of a map with a small scale. Therefore, it is not so important in a practical situation that the update rate of the second map image is low in comparison with that of the second map image.

In the map display system 1, the geographic information 302 for a map with a scale A and the geographic information 302 for a map with a scale B may be selectively loaded to a shared memory section of the RAM 11 by reason that a period in which the first map image 304a is generated overlaps with a period in which the second map image 304b is generated overlaps with a period in which the first map image 304a is generated. Therefore, the map display system 1 according to the present invention can be reduced in the capacity of the RAM 11, and in production cost.

It is preferable that the map display system 1 perform the operation in steps S605 and S606 regardless of whether the answer in step S601 is “Yes” or “No” as shown in FIG. 6. More specifically, the first and second mark images 305a and 305b, which are smaller in quantity of data than the first and second map images 304a and 305a, are updated in the same period. Therefore, even if the first map image 304a and the second map image 304b are updated in respective periods different from each other, the current position and the traveling direction of the vehicle are accurately indicated on the maps of the display devices 30 and 31.

In the above explanation, the map display system 1 comprises a first input device 40 and a second input device 41 physically-separated from the first input device 40. However, the first and second input devices 40 and 41 may be collectively constituted by an input device.

While there has been explained in the foregoing description about the fact that the first and second mark images 305a and 305b are respectively overlaid on the first and second map images 304a and 304b, the first and second mark images 305a and 305b may not be respectively overlaid on the first and second map images 304a and 304b.

### INDUSTRIAL APPLICABILITY OF THE INVENTION

The map display system according to the present invention is suitable for in-vehicle navigation system or the like to be required to reduce in processing workload on a processor.

1. A map display system comprising:
a first map image generating section configured to generate a first map image;
a second map image generating section configured to generate a second map image larger in scale than said first map image at intervals lower than intervals which said first map image is generated at; and
a display section configured to display said first map image generated by said first map image generating section and said second map image generated by said first map image generating section.

2. A map display system according to claim 1, wherein
said second map image generating section generates said second map image at intervals based on a ratio between the scale of said first map image and the scale of said second map image.

3. A map display system according to claim 1, further comprising:
a first mark image generating section configured to generate a first mark image indicating a current position and a traveling direction of a moving object, said first mark image being overlaid on said first map image; and
a second mark image generating section configured to generate a second mark image indicating said current position and said traveling direction of said moving object, said second mark image being overlaid on said second map image.

4. An integrated circuit, comprising:
a first map image generating section configured to generate a first map image;
a second map image generating section configured to generate a second map image larger in scale than said first map image at intervals lower than intervals which said first map image is generated at; and
a transferring section configured to transfer said first map image generated by said first map image generating section and said second map image generated by said first map image generating section to an external display section.
